(19) United States
(12) Patent Application Publication
(10) Pub. No.: US 2008/0059944 A1
(43) Pub. Date: Mar. 6, 2008

(54) DEPLOYMENT-AWARE SOFTWARE CODE GENERATION

(75) Inventors: Neil PATTERSON, Richmond (CA); David McCORMACK, Ottawa (CA); Tobin McCLEAN, Ottawa (CA); John HOGG, Kanata (CA); Mark HERMELING, Ottawa (CA); Eric GERVAIS, Gatineau (CA); Francis BORDELEAU, Gatineau (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: ZELIGSOFT INC., Gatineau (CA)

(21) Appl. No.: 11/838,578

(22) Filed: Aug. 14, 2007

Related U.S. Application Data
(60) Provisional application No. 60/822,410, filed on Aug. 15, 2006.

(51) Int. Cl. G06F 9/44

(52) U.S. Cl. 717/104

(57) ABSTRACT

A method and product for deployment-aware code generation in a distributed embedded system is described. The method generally comprises defining source and target component structural models by graphically modeling components and component structural features. The source component structural model is then mapped to the target component structural model to define a staging between the source and target component structural models, preferably also graphically. The staging is then combined with configurations of the source and target component structural models to fully specify a deployment from which code can be automatically generated for the embedded system. As opposed to platform-aware code generation that depends on the component and the platform on which the component is deployed, deployment-aware code generation depends not only on the location of the component being generated, but also on the location of other components.

### CROSS-REFERENCE TO RELATED APPLICATIONS

This application claims the benefit of priority of U.S. Provisional Patent Application No. 60/822,410, filed Aug. 15, 2006, which is incorporated herein by reference in its entirety.

### FIELD OF THE INVENTION

The present invention relates generally to automated code generation. More particularly, the present invention relates to deployment-aware code generation and deployment modeling, such as for distributed embedded systems.

### BACKGROUND OF THE INVENTION

Software development best practices include modeling the software graphically using a notation such as the Unified Modeling Language (UML). A software model shows the elements of a system and their relationships. It enables developers to clearly communicate with each other. Software models can include many aspects of a system, both structural and behavioural. Three important aspects are application modeling, platform modeling and deployment modeling. Application modeling describes the software parts (components) of a unit of functionality and their relationships. Platform modeling describes the hardware devices on which a set of applications are deployed and the software components that provide access to the hardware. Deployment modeling describes the assignment of software application components to hardware devices or software entities, such as processes and threads.

A graphical software model notation can also function as a programming language. A notation can have precise semantics and a syntax that can be stored and manipulated in a computer. A software development tool can transform the model into code that makes up part or all of an application. This approach is referred to as “model-driven development” (MDD) or “model-driven architecture” (MDA). MDD tools have been available commercially for many years. In general, MDD tools have concentrated on generating code for a single general-purpose processor (GPP), in contrast to generating code for a system of processors including specialized hardware processors (SHPs), such as digital signal processors (DSPs) and field-programmable gate arrays (FPGAs).

Some tools or tool add-ins, such as Connexis™ for IBM Rational Rose RealTime™, support generation of communication code for distributed systems. These tools use a library of middleware code which manages creation of connections between components' interfaces and message send/receive. The middleware is either proprietary or based on a standard such as CORBA. The code generated for each component uses the standard API (application programming interface) of the middleware package. Such generated code may be platform-dependent, i.e. the code generated for a component may reflect the environment for which it is generated, such as the language, compiler, operating system or core framework. However, the generated code is generally independent of the relative locations of the communicating components; i.e. it is deployment-independent.

This location independence increases component reusability in different contexts and simplifies changing component architectures. However, embedded architects and developers are usually concerned about performance, including latency (the time from some stimulus until a result is returned or an action occurs), bandwidth (the amount of processing that can be done in a unit of time) and footprint (the amount of memory consumed). Developers typically improve or tweak many performance measures by hand, in part, by optimizing based on knowledge of component layout in a system. For example, two components on a single processor may communicate through shared memory: one component writes a message in a shared location and the other component reads from the same location. This kind of optimization is not possible if components are independently generated.

It is, therefore, desirable to provide a deployment-aware method and system for automated code generation, particularly for distributed embedded systems.

### SUMMARY OF THE INVENTION

In a first aspect, the present invention provides method of deployment-aware code generation particularly applicable for designing distributed embedded systems. The method commences by defining source and target component structural models, where the component structural features comprise parts, ports and connectors, by modeling components and component structural features. The source component structural model can be an application model and the target component structural model can be a logical platform model, or the source component structural model can be a logical platform model and the target component structural model can be a physical platform model. The source component structural model is then mapped to the target component structural model to define a staging between the source and target component structural models. The staging between the source and target component structural models is then combined the with configurations of the source and target component structural models to fully specify a deployment. The configurations of the components and their structural features can be pre-defined or configured during the modeling or deployment process. Code can then be automatically generated for the embedded system based on the fully specified deployment.

According to further embodiments of the method, the source and target component structural models are preferably graphically modeled, and the mapping of the source component structural model to the target component structural model comprises graphically associating the components and component structural features in the source component structural model with components and component structural features in the target component structural model, including specifying connection paths between respective components and parts to model connectors. Different connection path can model different communication protocols.

Mapping one component or component structural features can automatically define a staging between other related components or component structural features. The staging specified between the source and target component structural models can be reusable against a plurality of source and target configurations, and mapping the source component structural model to the target component structural model can further comprise composing one or more previously-defined stagings from source components to target components, such as the staging of a component part to a component, the staging of a component to a component part, or the staging of a component part to a component part. Deployments themselves can also be reused, and mapping the source component structural model to the target component structural model can further comprise composing previously-defined deployments.

Automatically generating code can involve optimizing the code based on specifications of the fully specified deployment. The location and interoperation of components and parts can permit the optimization of, for example, security aspects, encryption aspects, and fault management behaviour.

According to a further aspect, the present invention also provides a computer-readable medium storing computer-executable instructions that, when executed, cause a computer to execute the method of deployment-aware code generation described above.

### BRIEF DESCRIPTION OF THE DRAWINGS

Embodiments of the present invention will now be described, by way of example only, with reference to the attached Figures, wherein:

FIG. 1 is an exemplary embodiment of a graphical modeling environment according to the present invention;

FIG. 2 is a block diagram of a generic component;

FIG. 3 is a flowchart of an embodiment of the method of the present invention;

FIG. 4 is an example of source to target mapping; and

FIG. 5 is a further example of source to target mapping.

### DETAILED DESCRIPTION

Generally, the present invention provides a method and product for deployment-aware code generation in a distributed embedded system. According to presently preferred embodiments, the method generally comprises defining source and target component structural models by graphically modeling components and component structural features. The source component structural model is then mapped to the target component structural model to define a staging between the source and target component structural models, preferably also graphically. The staging is then combined with configurations of the source and target component structural models to fully specify a deployment from which code can be automatically generated for the embedded system. As opposed to platform-aware code generation that depends on the component and the platform on which the component is deployed, deployment-aware code generation depends not only on the location of the component being generated, but also on the location of other components. Other aspects and features of the present invention will become apparent to those ordinarily skilled in the art upon review of the following description of specific embodiments of the invention in conjunction with the accompanying figures.

Embodiments of the present invention provide a graphical programming or modeling environment in which a graphical program or model is defined or specified, and code is automatically generated. The present invention is particularly applicable to multiprocessor systems in which two or more coupled processors each carry out one or more processes, tasks or functions, such as applications and sets of instructions. The multiprocessor system can be, for example, a distributed embedded system.

Embodiments of the invention can be represented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention can also be stored on the machine-readable medium. Software running from the machine-readable medium can interface with circuitry to perform the described tasks.

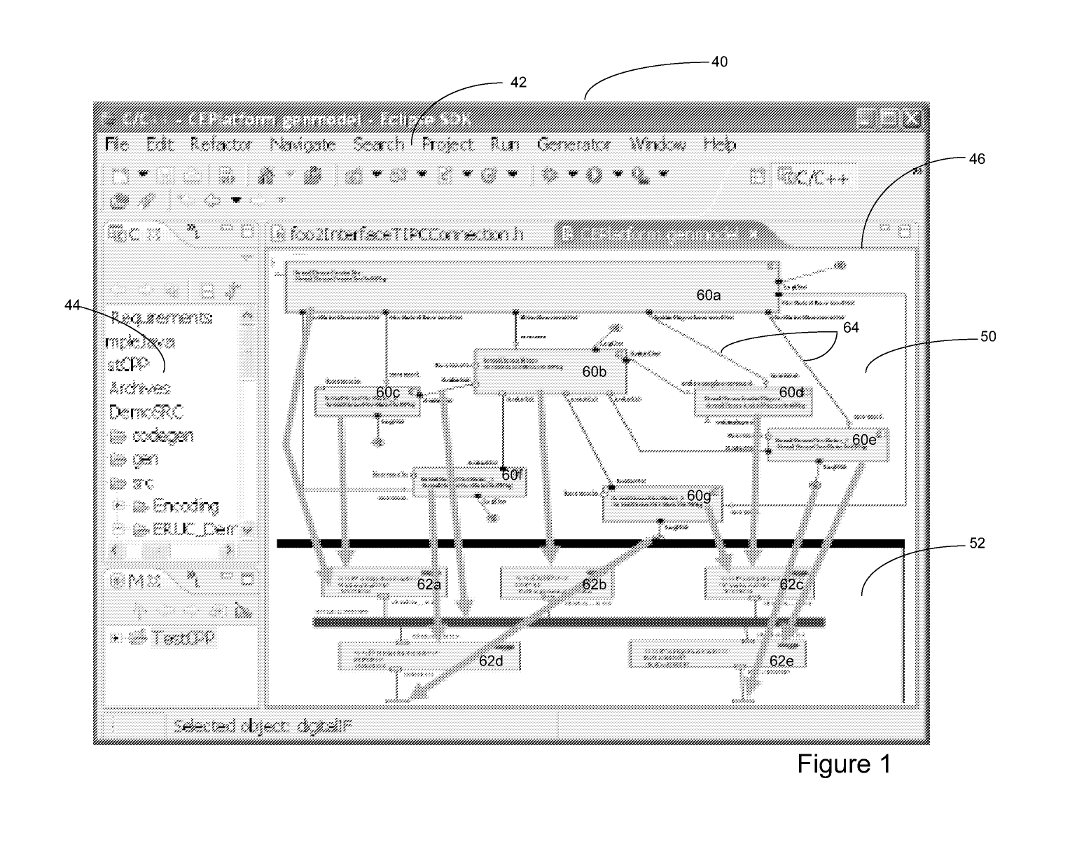

FIG. 1 illustrates a graphical modeling environment 40 according to an embodiment of the present invention. The graphical modeling environment 40 includes typical graphical user interface functionality, such as toolbars 42, a sidebar 44, and a main display area 46. The main display area 46 displays a source component structural model 50 and a target component structural model 52 in separate windows. As will be appreciated by those of skill in the art, the block diagrams representing the source and target component structural models 50, 52 are merely exemplary. As will also be appreciated, by simple click navigation or other conventional means, the main display area 44 can be configured to display single models, components of the models, configuration information for particular components, and any other views applicable to the modeling process.

A component structural model, such as source and target component structural models 50 and 52, is the representation of some aspect or aspects of software or hardware systems or parts of systems. A number of different models can be defined within the system of the present invention. An application model is a representation of an application. A physical platform model is a representation of the physical hardware, or devices, on which a system is implemented. A logical platform model is the representation of the logical devices, services, execution contexts and similar elements of the system software running on a hardware platform consisting of one processor or a plurality of processors. It is possible to combine physical and logical platform models, and it is also possible to model aspects of physical or logical platforms in an application model. This does not change the fundamental nature of any model. A deployment model represents the assignment of the component instances of one or more applications to the devices of a platform. As used herein, an application is a configured and interconnected set of one or more components deployed as a unit to deliver some end-to-end capability. A platform is a set of connected devices on which one or more applications may execute.

A device is a unit of hardware (typically a processor) on which a component instance executes. A physical device is an actual hardware device, such as a PowerPC GPP. A logical device is a component providing access to devices for components. A logical device may not execute on its physical device; for instance, the logical device providing an interface to an FPGA (Field Programmable Gate Array) usually executes on a GPP. A (logical) device definition defines the interface of a logical device in a manner analogous to a component definition defining the interface of a component. A logical device implementation is a realization of a logical device in a particular operating environment. A logical device instance is a component instance that is a manifestation of a logical device in an executing system. A physical device instance is an instance of a physical device in a platform—e.g., a specific PowerPC on a board.

Each of the source and target models 50 and 52 is composed of components, represented by the blocks 60a-g and 62a-e interconnected by connectors 64. A component has an internal structure with features, referred to herein as component structural features. Features include parts, ports of various types and connectors. Parts are roles played by sub-components to perform portions of the component behavior. Each part has part ports corresponding to the external interface of the component playing the part. A port is a directed interface through which a component communicates. A port instance is the manifestation of a port on a component instance. A connection is the association of two port instances in an application to specify or define a communication path. A connection is modeled as a connector, as will be described further below.

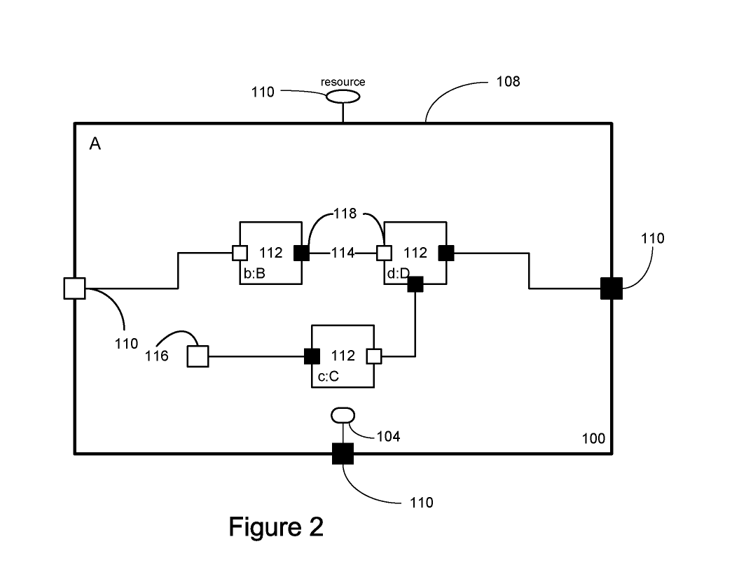

FIG. 2 shows a schematic representation of a generic component 100. Component 100 is an independently defined unit of software functionality that is individually deployable and re-usable. A component has a functional code portion that is accessed through one or more component internal APIs 104. The component packaging 106 has a component outer API 108 that provides the interface between the component and its external environment, such as other components. The outer API 108 includes ports and interfaces 110. Each port has zero or more interfaces. Interfaces can be organized in interface contracts. A component definition defines the interface or “software contract” of a component, including its externally visible properties and operations. External ports 110 are the ports defining the external interface of the component. Behavior ports 104 communicate with the realization behavior of the component. Service ports 116 communicate with services provided elsewhere in the system. Part ports 118 communicate with the components playing the composed parts of the component. Connectors 114 define the connectivity between the external, behavior, service and part ports of the component structure. The component parts 112 are in turn specified as components which may have their own realizations and structure. Hence, a component may have a complex hierarchical structure.

A component provides functionality to its environment (which typically consists of other components), and requires services from its environment (typically other components). The set of provided and required services is indicated by the provided and required interfaces on the ports 110 of a component. In other words the ports of a component describe the behavior that the component reacts to and can initiate. A component has a realization or implementation of part or all of the component behavior. A component implementation is a realization of a component definition for a particular operating environment (language, real-time operating system (RTOS), processor, communication middleware, etc.). It is a template from which component instances are created. A component instance is the manifestation of a component in an application. Component behavior may also be implemented by the component internal functional code portion 102.

In addition to their structural features, components are also separately provided with one or more configurations. A configuration specifies properties of an element in a model. Element configurations can be specialized for each structural feature type. A component configuration specifies attribute properties associated with the component itself, such as processor type and memory requirements for its behavior; the realization (implementation) of the component to be used; and the part configurations for each of its parts. A part configuration specifies attribute properties associated with the component in the context of the part; the cardinality (number of copies) of the part, if the number is not specified in the component structural definition; the component playing the part; and a configuration of the component. Connectors and ports may also be configured with properties such as address information. Configuration of parts or components can be achieved in many ways. Possibilities include displaying a dialog window in response to selecting the component to set the properties of the component itself or a feature of the component, or providing pre-defined configurations for components and their features.

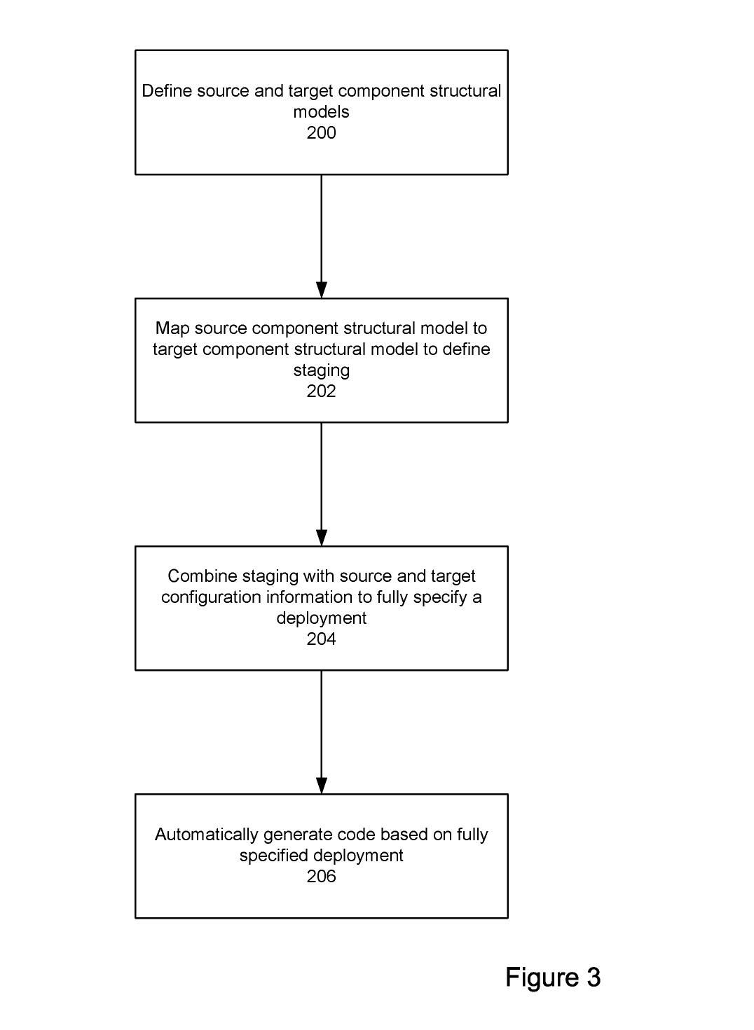

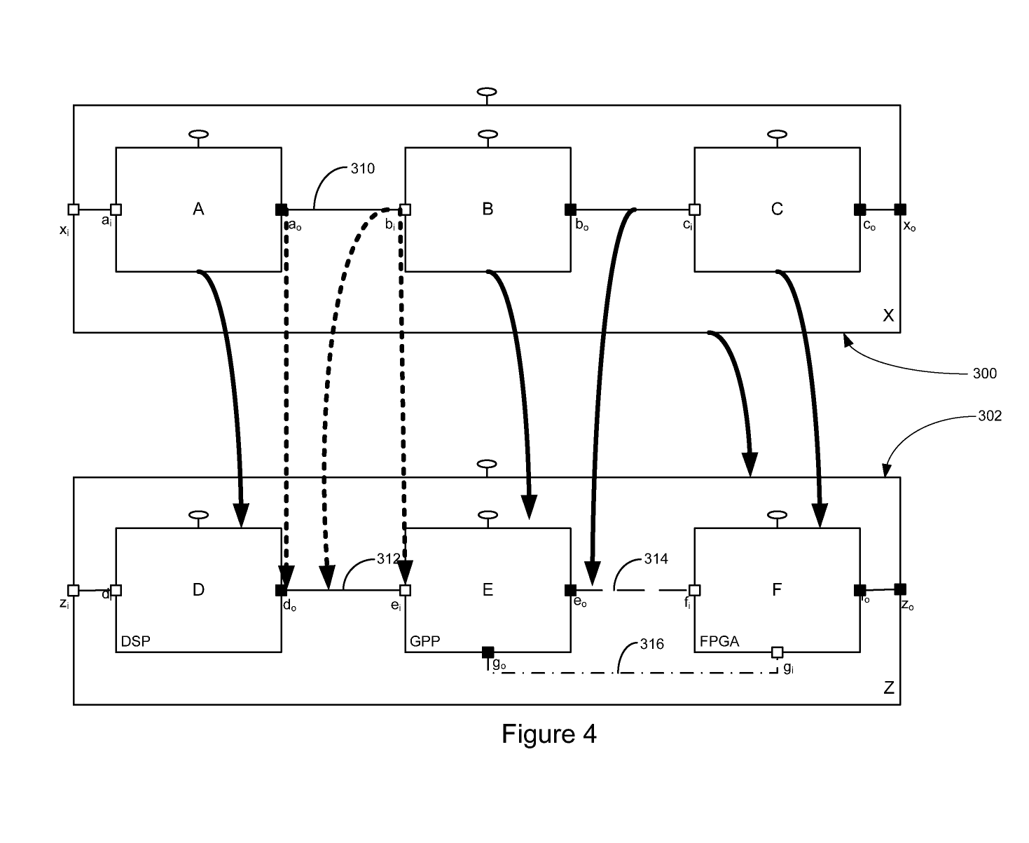

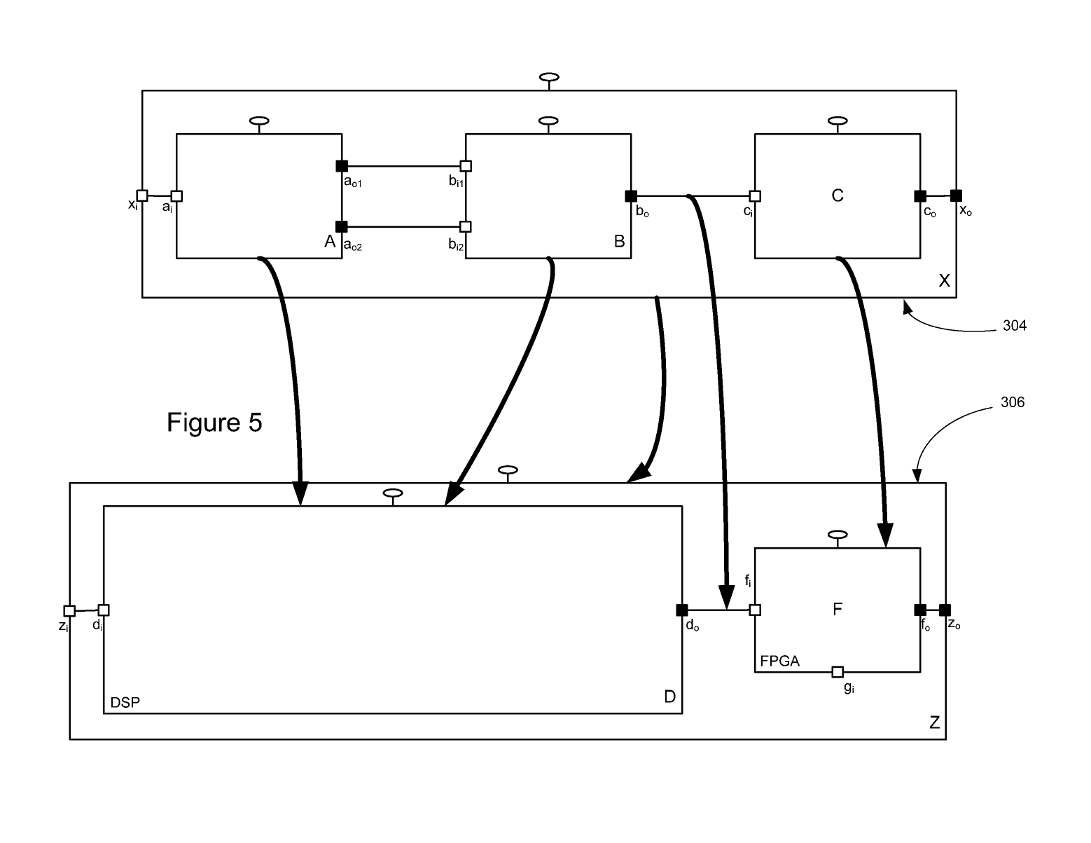

The method of the present invention will now be described with reference to FIGS. 3, 4 and 5. FIG. 3 is a flowchart of the method. FIGS. 4 and 5 show generic source and target models and the mappings therebetween. The method starts by defining the source and target models by modeling the components and their respective component structural features (step 200). Component structure can be modeled and defined using numerous tools, such as Zeligsoft CE™ by Zeligsoft Inc., or any other suitable modeling tool. For ease of understanding, simple generic source and target models are shown in each of FIGS. 4 and 5. The source model can be, for example, an application model, and the target model can be a logical platform model. As will be understood by those of skill in the art, the source and target models can be application, logical platform or platform models. A source application model can be deployed to a target logical platform model; while a source logical platform model can be deployed to a target physical platform model.

Referring to FIG. 4, the source model 300 consists of a component X, having three parts A, B and C. In an application model, component X and its parts A, B and C would be application components describing separate functions. The parts A, B and C could themselves include parts or sub-components as described above. Part A is provided with two ports aᵢ and aₒ. Similarly, parts B and C are provided with ports bᵢ, bₒ, cᵢ and cₒ, respectively. Connectors are modeled between ports aₒ and bᵢ, and ports bᵢ, and cᵢ. Target model 302 consists of component Z, having parts D, E and F. In a logical platform model, part D could be, for example, a logical DSP device; part E could be a GPP and part F could be a logical FGPA device. Each of parts D, E and F are also provided with ports dᵢ, dₒ, eᵢ, eₒ, fᵢ and fₒ. In addition, parts E and F are provided with ports gₒ and gᵢ, respectively, which define a second communication path between these components. The two communication paths (eₒ−fᵢ and gₒ−gᵢ) could, for example, operate under different communication protocols, as defined by their respective configurations.

In FIG. 5, the source model 304 also consists of a component X, having three parts A, B and C. Part A is provided with three ports aᵢ, aₒ₁, aₒ₂. Part B is modeled with ports bᵢ₁, bᵢ₂, and bₒ. And, part C is modeled with ports cᵢ and cₒ. Connectors are modeled between ports aₒ and bᵢ, and ports bₒ and cᵢ. Connectors are specified between ports aₒ₁-bᵢ₁, aₒ₂-bᵢ₂, and bₒ-cᵢ. Target model 306 consists of a component Z having parts D and E, where part D could be, for example, a logical DSP device, and part E could be a GPP. Parts D and E are also provided with ports dᵢ, dₒ, and eᵢ, eₒ.

Once the source and target models have been defined or modeled, components and parts from the source model must be mapped to the target model to eventually result in a full deployment of the source model. Deployment is the assignment of component instances to device instances. The term “deployment” has multiple meanings. For example it can mean delivering working systems to the field. It can also mean physically loading components (including logical devices) on physical devices. In this context it specifically means assigning components to source component parts to target component parts. At run time, this will be reflected as a source component instance executing on a target component instance, which could be a physical entity such as a processor or a logical entity such as a process. A deployment is a set of instance deployments.

Deployment begins by mapping the components from the source model to the target model to define a mapping between the components and component structural features of the models (step 202). This mapping from source to target structural elements is called a “staging”. At its simplest, a staging is a mapping from the structural features of a source component to the structural features of a target component. It specifies in part how the source component will be deployed onto the target component, although it lacks configuration information necessary to complete the specification. When a source component is deployed onto a target component the source component executes in the context of the target component. Examples are an application component executing in the context of a process of an RTOS in a logical platform model, or a logical platform RTOS executing on a physical platform GPP. The gesture for staging a component instance can be, for example, a conventional drag-and-drop from a window containing a source component to a window containing a target component, as shown by the arrows in FIGS. 1, 4 and 5. Using the graphical modeling environment 40 depicted in FIG. 1, a user can quickly specify a full staging of a complex platform and set of applications. A staging can also be graphically specified by dragging an element in a hierarchical directory-style view onto another element. These two can be mixed, and other embodiments are possible. In the example shown in FIG. 4, parts A, B and C are mapped to parts D, E and F, respectively. In FIG. 5, parts A and B are mapped to part D, and part C is mapped to part E.

All the features of a component structure can be staged. Specifically, connectors, ports and parts can be staged. A component staging specifies that the structural features of a source component are mapped to the structural features of a target component. A component staging comprises a set of feature stagings. A feature staging maps a feature of the source component to a feature of the target component. For example, in FIG. 4, the component staging for component X specifies the mapping of ports of xᵢ and xₒ to ports zᵢ, zₒ. Parts are staged similarly. A specific staging of one feature can also force a specific staging of other features. For instance, if two source parts, such as parts A and B, communicate through a single connector 310 and two target parts communicate through a single connector as shown by the connector 312 joining between ports dₒ and eᵢ in FIG. 4, staging the two source parts A and B to different target parts D and E will force the source connector 310 to be staged to the target connector 312 (as shown by the dotted arrow), and furthermore force the source ports to be staged to their respective target ports. Similarly, staging one of the source parts and the source connector will force the staging of the other source part and its ports. In FIG. 5, where parts A and B are mapped to part D, their respective parts A′, A″ and B′, B″, and the internal connections between them, will also be staged on part D.

Where more than one communication path can be defined between components and/or parts, such as the two communication paths 314 and 316 between parts E and F in FIG. 4, the user can specify the particular path to be used (such as by dragging and dropping between the source and target models), thereby staging the connector between the components or parts in the target model, as shown by the arrow from the connector between ports bₒ-cᵢ to the connector between ports eₒ-fᵢ.

Once the components have been staged, the configurations associated with the components and their structural features can be combined with the staging to fully specify the deployment (step 204). Thus, a deployment, as used herein, is a mapping from a configured source structure to a configured target structure. From this fully specified deployment, optimized code can then be automatically generated (step 206). The automated generation of code, or other artifacts, from a specified model is well-known in the art. In the present invention, the deployment is fully specified with both staging and configuration information, thus the code generation logic does not need to make further decisions concerning the deployment and code generation is simplified compared to other automated systems.

Generation of code or other artifacts used at execution time can be optimized by taking into consideration the location or placement of other related elements within the target model, the code generated for other elements, or the implementation of other elements. In particular, communication throughput, latency and memory use can be optimized. For example, if two components or parts are collocated on the same device (such as parts A and B staged on part D in FIG. 5), they can communicate through shared memory, using appropriate middleware. If the components or parts are on separate devices (such as parts B and C on parts D and E, respectively, in FIG. 5) they will instead use a more general communication technology or protocol to communicate. Thus, the communication code generated to enable the communication between parts A and B will differ from the communication code generated to enable communication between parts B and C. This permits optimization similar to hand-optimized systems without the need to implement complicated decision-making strategies in the code generation logic.

Deployment-aware generation can also be used to optimize certain security aspects. If two components are separate, communications between them must be appropriately encrypted. If they are collocated on a single device, encryption may not be necessary. Similarly, deployment-aware generation can be used to optimize failure behaviour. In embedded systems, the failure of one component may require action on the part of another component if it continues executing. When components are located in the same process, the failure of one will guarantee the failure of the other, and the second component does not need to implement failure-handling behaviour with respect to the first. Deployment-aware generation can also determine how parts of a component are generated and also how a component is distributed. For instance, a proxy can be generated if and only if two components must communicate through a channel requiring a proxy at one end. This may be necessary or desirable when a platform includes a hardware device that is optimized for signal processing but not control logic, such as an FPGA (Field Programmable Gate Array).

It is important to note that stagings can be reusable. A staging maps a source feature to a target feature. If either or both of the source and target features are parts, they may have complex internal structure themselves, and the mapping of this nested structure must also be specified in a complete staging description. The mapping of the internal structure can be specified by a reference staging to a previously-defined staging. A reference staging specifies a referenced staging (which stages one component to another), a source and a target. The staging being specified by reference may be larger than the staging being defined in either or both of two ways. The source component of the referenced staging may be playing a part in a larger source component. For example, an Encryption component may play a part in a VideoTransmission component. The staging of the Encryption component and its structure to a VideoBoard consisting of various general-purpose processors and digital signal processors can be used as a reference staging in the staging of the VideoTransmission component. The target component of the referenced staging can play a part in a larger target component. For example, the staging of the VideoTransmission above to a VideoBoard may be referenced in the staging of VideoTransmission to a GamingBox that includes a VideoBoard. These two expansions of the scope of a staging may be applied in parallel.

When a reference staging specifies the use of an existing staging in a larger source context (like Encryption in VideoTransmission in the first example above), the source of the reference staging is a part. If the source context is the same in both cases (such as the reuse of a VideoTransmission staging in a larger target context) the source is the source component of the staging. Similarly, when a reference staging specifies the use of an existing staging in a larger target context (such as VideoBoard in GamingBox in the second example above), the target of the reference staging is a part. If the target context is the same in both cases (such as the reuse of a staging to VideoBoard in the first example), the target is the target component of the staging. A reference staging can be used in stagings where both the source and reference contexts are larger than the referenced staging. In this case both the source and target of the referenced staging will be parts of the source and target component stagings, respectively. Referring to FIG. 1, one method of specifying a reference staging can include dragging from the source element (part or component) in the source window to the target element (part or component) in the target window, and, when the mouse button is released, presenting a menu of reference stagings that are applicable in the context. In other embodiments, previously-defined deployments can be similarly reused: multiple component deployments can be brought together in a larger deployment.

The method of the deployment-aware code generation of the present invention provides software developers with a number of advantages over previously-known modeling and code generation techniques. Deployment-aware generation produces optimized code without requiring hand-optimization. Embedded developers are usually extremely sensitive to software performance. Because of this, the adoption of code generation technology in embedded applications has significantly lagged behind its adoption in IT environments. Deployment-aware generation addresses embedded performance concerns by providing optimizations that an experienced embedded developer would do by hand. Automated deployment-aware generation also makes optimized code reconfigurable, reusable and portable. Hand-optimizing code is expensive and time consuming and it is not feasible to change it frequently. By contrast, deployment-aware generation frees the architect and developer to experiment with the best component deployment and system architecture. Optimized code can be generated and regenerated at little cost.

Deployment-aware generation according to the present invention can be used in a wide variety of environments. While most applicable in an embedded development, it can also be used in an IT context. Deployment-aware generation can also be used in homogeneous systems where all devices are identical or similar. Heterogeneous systems introduce more opportunities for generation patterns such as proxies.

The embodiments described above is based on a graphical modeling environment using a component-based approach. However, as long as the interfaces of the elements of a distributed system are clearly defined and appropriately configured, a variant of deployment-aware generation can be constructed.

In the preceding description, for purposes of explanation, numerous details are set forth in order to provide a thorough understanding of the embodiments of the invention. However, it will be apparent to one skilled in the art that these specific details are not required in order to practice the invention. In other instances, well-known electrical structures and circuits are shown in block diagram form in order not to obscure the invention. For example, specific details are not provided as to whether the embodiments of the invention described herein are implemented as a software routine, hardware circuit, firmware, or a combination thereof.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A method of deployment-aware code generation for a distributed embedded system, comprising steps of:
defining source and target component structural models by modeling components and component structural features;
mapping the source component structural model to the target component structural model to define a staging between the source and target component structural models;
combining the staging between the source and target component structural models with configurations of the source and target component structural models to fully specify a deployment; and
automatically generating code for the embedded system based on the fully specified deployment.

2. The method of claim 1, wherein defining the source and target component structural models comprises graphically modeling the components and the component structural features.

3. The method of claim 1, wherein the component structural features comprise parts, ports and connectors.

4. The method of claim 3, wherein mapping the source component structural model to the target component structural model comprises graphically associating the components and component structural features in the source component structural model with components and component structural features in the target component structural model.

5. The method of claim 1, wherein mapping one component or component structural features automatically defines a staging between other related components or component structural features.

6. The method of claim 1, further including defining the configurations associated with each of the source and target component structural models.

7. The method of claim 6, wherein defining the source component structural model comprises specifying a connection path between respective components to model a connector.

8. The method of claim 7, wherein the connection path models one of a plurality of communication protocols.

9. The method of claim 1, wherein the source component structural model is an application model and the target component structural model is a logical platform model.

10. The method of claim 1, wherein the source component structural model is a logical platform model and the target component structural model is a physical platform model.

11. The method of claim 1, wherein the staging between the source and target component structural models is reusable against a plurality of source and target configurations.

12. The method of claim 11, wherein mapping the source component structural model to the target component structural model further comprises composing one or more previously-defined stagings from source components to target components.

13. The method of claim 12, wherein a reusable staging is applied to the staging of a component part to a component.

14. The method of claim 12, wherein a reusable staging is applied to the staging of a component to a component part.

15. The method of claim 12, wherein a reusable staging is applied to the staging of a component part to a component part.

16. The method of claim 1, wherein deployments are reusable, and wherein mapping the source component structural model to the target component structural model further comprises composing previously-defined deployments.

17. The method of claim 1, wherein automatically generating code comprises optimizing the generated code based on specifications of the fully specified deployment.

18. The method of claim 12, wherein optimizing the generated code comprises optimizing security aspects of the generated code.

19. The method of claim 18, wherein the security aspects comprise encryption aspects.

20. The method of claim 12, wherein optimizing the generated code comprises optimizing fault management behaviour.

21. A computer-readable medium storing computer-executable instructions that, when executed, cause a computer to execute a method of deployment-aware code generation, comprising steps of:
defining source and target component structural models by modeling components and component structural features;
mapping the source component structural model to the target component structural model to define a staging between the source and target component structural models;
combining the staging between the source and target component structural models with configurations of the source and target component structural models to fully specify a deployment; and
automatically generating code for an embedded system based on the fully specified deployment.

22. A method of deployment-aware code generation for a distributed embedded system, comprising steps of:
defining source and target component structural models by graphically modeling components and component structural features, the component structural features comprising parts, ports and connectors;
defining configurations associated with each of the source and target component structural models;
mapping the source component structural model to the target component structural model, by graphically associating the components and component structural features in the source component structural model with components and component structural features in the target component structural model, to define a reusable staging between the source and target component structural models;
combining the staging between the source and target component structural models with configurations of the source and target component structural models to fully specify a deployment; and
automatically generating and optimizing code for the embedded system based on specifications of the fully specified deployment.

23. The method of claim 22, wherein mapping one component or component structural features automatically defines a staging between other related components or component structural features.

24. The method of claim 22, wherein defining the source component structural model comprises specifying a connection path between respective components to model a connector.

25. The method of claim 24, wherein the connection path models one of a plurality of communication protocols.

26. The method of claim 22, wherein the source component structural model is an application model and the target component structural model is a logical platform model.

27. The method of claim 22, wherein the source component structural model is a logical platform model and the target component structural model is a physical platform model.
